(19) United States
(12) Patent Application Publication
(10) Pub. No.: US 2018/0364520 A1
(43) Pub. Date: Dec. 20, 2018

(54) CURVED DISPLAY APPARATUS AND METHOD FOR CONTROLLING ROTATION ANGLE THEREOF

(71) Applicant: Chongqing HKC Optoelectronics Technology Co., Ltd., Chongqing (CN)

(72) Inventor: Chia-Hang Lee, Chongqing (CN)

(21) Appl. No.: 15/556,094

(22) PCT Filed: Mar. 24, 2017
(86) PCT No.: PCT/CN2017/078128

§ 371 Date: Jul. 10, 2018

(30) Foreign Application Priority Data
Dec. 31, 2016 (CN) 201611268778.X

(51) Int. Cl. G02F 1/1335; G02F 1/1333

(52) U.S. Cl. CPC G02F 1/133514; G02F 2001/133314; G02F 1/133305; G02F 1/133602

(57) ABSTRACT

This application relates to a curved display apparatus and a method for controlling a rotation angle thereof. The curved display apparatus includes: a flexible display module; and an angle adjustment module, coupled to the flexible display module, and configured to adjust a rotation angle of the flexible display module. The angle adjustment module includes: a rotation control mechanism unit, having a gear; a motor control unit, having a motor, where the motor is connected to the gear; and a observer location information detection unit, electrically coupled to the motor control unit, and configured to sense a observer image. By means of this application, a rotation angle of a display is automatically adjusted according to a location change of a observer, to adjust a rotation angle of a curved display apparatus, thereby greatly improving image quality at a large viewing angle of an observer.

### BACKGROUND

### Technical Field

This application relates to a method for designing a curved surface, and in particular, to a curved display apparatus and a method for controlling a rotation angle thereof.

### Related Art

With development of display technologies, in addition to improvement in sizes and image quality, appearances of display devices, such as curved display devices, are also changed. Compared with a flat display device, the curved display device not only can have a larger size with a same width, but also can provide a better visual effect. Using a flat television and a curved television as an example, when the audience's sight moves from the very center of the screen of the flat television to two sides of the television, the audience always finds that the edges of the flat television have a relatively poor visual effect. Especially, a conventional flat liquid crystal display (regardless of a vertical alignment (VA) type or an in-plane switching (IPS) type) television has a color difference between a large viewing angle and a central viewing angle during watching. Consequently, the image quality becomes poorer as the viewing angle becomes larger. The curved television has a curved design. Therefore, image distortion on the edges of the screen may be reduced, and the sense of immediacy is improved during watching.

For a conventional curved display device, an entire substrate is bended to be a curve having a same curvature. However, in this manner, a peripheral circuit (for example, a gate drive circuit) formed on the substrate bears a bending stress in a process of manufacturing a curved surface by bending a thin film transistor array substrate, and a circuit property is also affected. For example, a decrement of electronic mobility and an increment of a critical voltage cause a decrement of a drive capability of a circuit, and circuit reliability becomes poorer. In other words, when a display device is designed to a curved display device having a better visual effect, original circuit performance is affected. Therefore, a structure of an existing curved display device still needs to be improved.

### SUMMARY

To resolve the foregoing technical problem, an objective of this application is to provide a method for designing a curved surface, and in particular, a curved display apparatus and a method for intelligently controlling a rotation angle thereof. Therefore, an intelligent method for automatically controlling a rotation angle of a curved display apparatus is designed by using an angle control signal generated by a rotation control mechanism unit, a motor controller, and a user location information detection unit.

The objective of this application is achieved and a technical problem of this application is resolved by using the following technical solution: A curved display apparatus provided according to this application comprises: a flexible display module; and an angle adjustment module, coupled to the flexible display module, and configured to adjust a rotation angle of the flexible display module.

The objective of this application may be further implemented and the technical problem of this application may be further resolved by using the following technical solutions:

A method for controlling a rotation angle of a curved display apparatus comprises: providing the curved display apparatus; generating a control signal according to location information of an object image detected by the observer location information detection unit; controlling rotation of the motor of the motor control unit according to the control signal; and controlling a rotation angle of the flexible display module by means of a rotation degree of the rotation control mechanism unit.

In an embodiment of this application, the flexible display module comprises: a cover, having a first curved surface; and a backplane, disposed opposite to the cover and having a second curved surface.

In an embodiment of this application, the flexible display module further comprises a liquid crystal display panel, disposed between the backplane and the cover.

In an embodiment of this application, the angle adjustment module comprises: a rotation control mechanism unit, having a gear; a motor control unit, having a motor, where the motor is connected to the gear; and a user location information detection unit, having a charge-coupled assembly, electrically coupled to the motor control unit, and configured to sense an object image.

In an embodiment of this application, the motor is a step motor.

In an embodiment of this application, the user location information detection unit comprises a rotation angle calculation assembly, configured to automatically analyze an angle by which a user deviates from a central plane of a display.

In an embodiment of this application, the user location information detection unit further comprises a signal processor, configured to analyze a distance by which a user deviates from a center of a display.

In an embodiment of this application, in the method, the step of controlling a rotation angle of the flexible display module by means of a rotation degree of the rotation control mechanism unit comprises: connecting to the backplane of the flexible display module by using the rotation control mechanism unit; adjusting the second curved surface of the backplane by means of rotation of the gear; and adjusting a rotation angle of the first curved surface of the cover by adjusting a rotation angle of the second curved surface.

In an embodiment of this application, in the method, the motor is a step motor.

In an embodiment of this application, in the method, the user location information detection unit may be a sensor chip or a sensor.

By means of this application, a rotation angle of a display is automatically adjusted according to a location change of a user, to adjust a rotation angle of a curved display apparatus, thereby greatly improving image quality in a large viewing angle of an observer.

### BRIEF DESCRIPTION OF THE DRAWINGS

FIG. 1a is an exemplary schematic diagram of a television angle;

FIG. 1b is an exemplary schematic diagram of a vertical color difference and a horizontal color difference;

FIG. 2a is an exemplary schematic diagram of a gamma curve of a pixel;

FIG. 2b is an exemplary schematic diagram of controlling a gamma curve of a pixel by using a voltage;

FIG. 3 is an exemplary schematic diagram of a relationship between different viewing angles at which a observer watches a display and different distances between the observer and the display;

FIG. 4 is another exemplary schematic diagram of a relationship between different viewing angles at which observers watch a display and different distances between the observers and the display;

FIG. 5 is a schematic diagram of a curved display apparatus according to an embodiment of this application;

FIG. 6 is a flowchart of an intelligent method for controlling a rotation angle of a curved display apparatus according to an embodiment of this application;

FIG. 7 is a schematic diagram of a observer location information detection unit configured to detect locations of observers according to an embodiment of this application;

FIG. 8 is a schematic diagram of a curved display apparatus according to another embodiment of this application;

FIG. 9 is a schematic operational diagram of a rotation control mechanism unit according to an embodiment of this application; and

FIG. 10 is a schematic operational diagram of a curved display apparatus according to an embodiment of this application.

### DETAILED DESCRIPTION

Reference accompanying drawings are described in the following embodiments, and are used to show that this application may be used to implement a particular embodiment. Direction terms mentioned in this application, for example, “up”, “down”, “front”, “rear”, “left”, “right”, “inside”, “outside”, and “side”, are merely directions in the reference accompanying drawings. Therefore, the used direction terms are used to describe and understand this application, but not intended to limit this application.

The accompanying drawings and specification are essentially exemplary instead of restrictive. In the drawings, units having similar structures are represented by same numbers. In addition, for ease of understanding and description, the size and thickness of each component shown in the accompanying drawings are random. However, this application is not limited thereto.

In the accompanying drawings, for the purpose of clearness, the thicknesses of a layer, a film, a panel, an area, and the like are exaggerated. In the accompanying drawings, for ease of understanding and description, the thicknesses of some layers and areas are exaggerated. It should be understood that when a component of, for example, a layer, a film, an area, or a base is referred to as “on” another component, the component may be directly on the another component, or there may be an intermediate component.

In addition, in the specification, unless explicitly described to the contrary, the term “include” is understood as including the component but not to exclude any other components. Moreover, in the specification, “on” means above or under a target component, but does not necessarily mean on the top based on the direction of gravity.

To further describe the technical measures and functions used in the this application to implement the predetermined objectives, specific implementations, structures, features, and functions of a curved display apparatus and a method for controlling a rotation angle thereof provided in this application are described in detail below with reference to the accompanying drawings and preferred embodiments.

The display apparatus in this application may include a liquid crystal display panel and a backlight module disposed opposite to each other. The liquid crystal display panel mainly includes a color filter substrate, a thin film transistor substrate, and a liquid crystal layer disposed between the two substrates. The color filter substrate, the thin film transistor substrate, and the liquid crystal layer may form a plurality of pixel units configured in arrays. The backlight module may emit light passing through the liquid crystal display panel, and the pixel units of the liquid crystal display panel display colors to form an image.

In an embodiment, the liquid crystal display panel in this application may be a curved display panel, and the display apparatus in this application may be a curved display apparatus.

A curved display is a display having a curved display panel. When the curved display is watched, distances between eyes of audience and various locations on the curved display are approximately equal. Regardless of an image displayed in the central region or a right or left edge region, the audience may directly watch the display approximately at a right angle. Therefore, compared with a flat display, the curved display does not have problems such as brightness differences and color differences. In addition, the curved display has a visual effect similar to a stereoscopic effect. Therefore, the curved display has become an eye-catching display product. However, the curved display is formed by bending a flat display panel by an external force. Therefore, a relative location offset may occur between two substrates. As a result, a light leakage problem may be caused, and display quality of the curved display is affected.

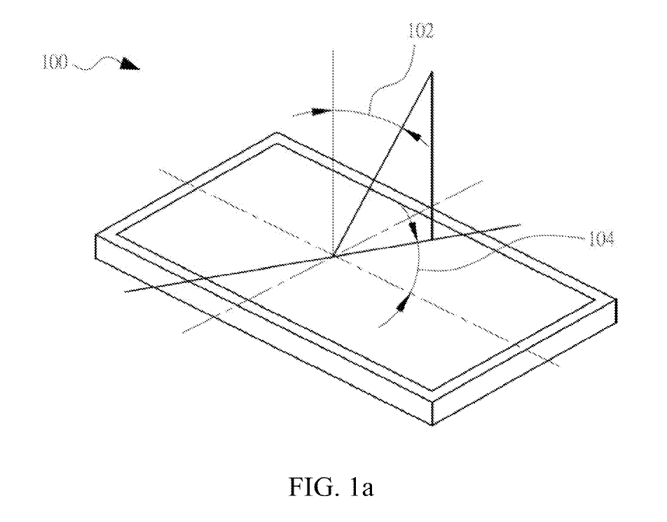

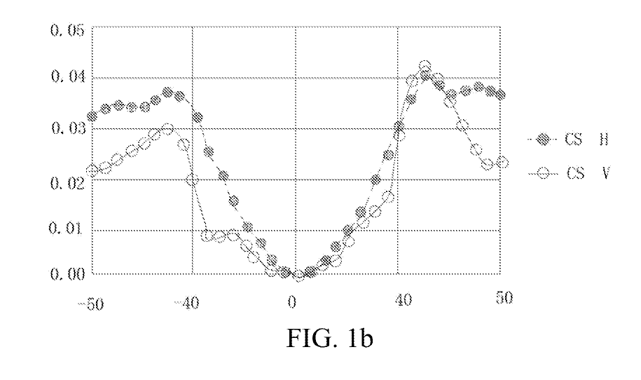

FIG. 1a is an exemplary schematic diagram of a television angle, and FIG. 1b is an exemplary schematic diagram of a vertical color difference and a horizontal color difference. Referring to FIG. 1a and FIG. 1b, at present, more televisions are designed with a curved plane. In addition to the novel appearance design, the main reason is outstanding performance in image quality display. In particular, for a conventional flat liquid crystal display 100, a vertical alignment (VA) type, or an in-plane switching (IPS) type television generally has problems of horizontal color differences and vertical color differences between a normal angle 102 of a central viewing angle and a horizontal angle 104 of the central viewing angle during watching in a large viewing angle. Consequently, the image quality becomes poorer as the viewing angle becomes larger.

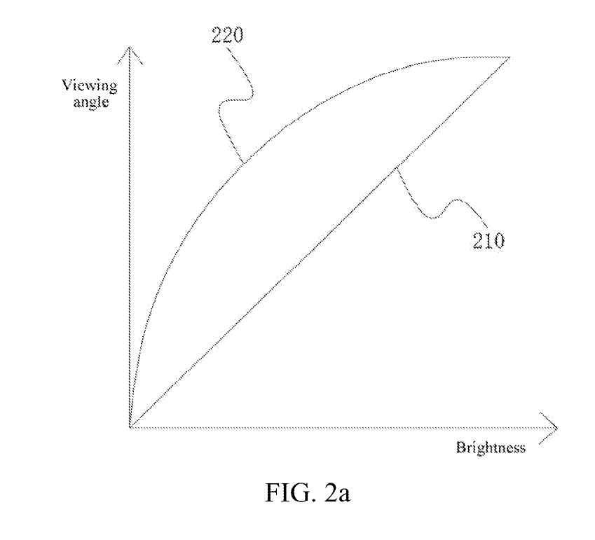

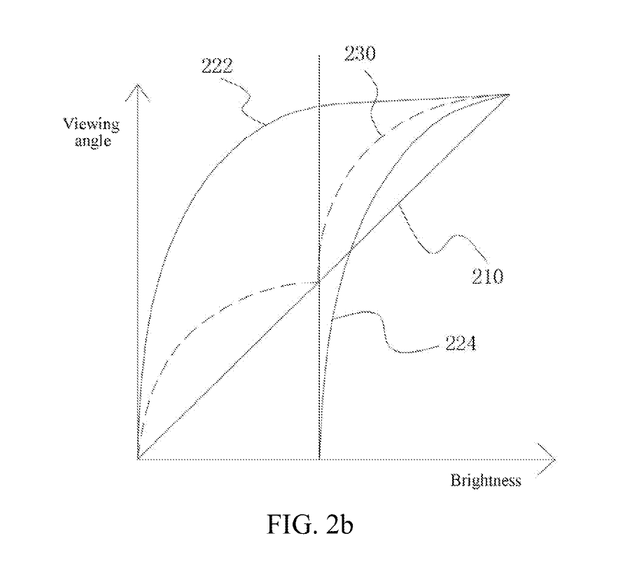

FIG. 2a is an exemplary schematic diagram of a gamma curve of a pixel, and FIG. 2b is an exemplary schematic diagram of controlling a gamma curve of a pixel by using a voltage. Referring to FIG. 2a and FIG. 2b, in a conventional manner for improving a viewing angle of a liquid crystal display, one pixel is divided into two subpixels, namely, a subpixel A and a subpixel B. A gamma curve 222 of the subpixel A and a gamma curve 224 of the subpixel B are controlled by using a voltage. The gamma curve 222 of the subpixel A and the gamma curve 224 of the subpixel B are combined into a gamma curve 230. The gamma curve 230 is different from a conventional gamma curve 220, and is close to an ideal gamma curve 210, so as to compensate for and improve a color difference at a side viewing angle. Such a method is referred to as a space pixel compensation method.

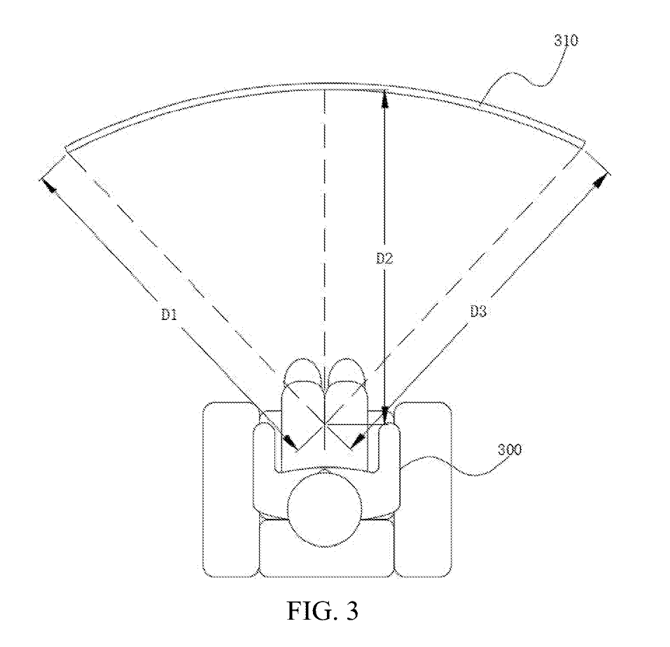

FIG. 3 is an exemplary schematic diagram of a relationship between different viewing angles at which a observer 300 watches a display 310 and different distances between the observer 300 and the display 310. Referring to FIG. 3, when the observer watches a flat display, a distance between a center of a display image on the flat display and the observer is not equal to a distance between two sides of the display image and the observer. Consequently, an image watched by the observer is distorted. Therefore, a curved display 310 is proposed. When the observer 300 watches the curved display 310, because the distance between the center of the display image on the curved display 310 and the observer 300 is close to the distance between two sides of the display image on the curved display 310 and the observer, an image watched by the observer 300 is more real, and the feeling of fatigue during watching is reduced. Therefore, another method for improving image quality in a large viewing angle is using a curved display, that is, corresponding curvatures of a display are calculated for set watching distances D1, D2, and D3. Generally, a curvature of a display is approximately R2000, and a curvature of a television is approximately R4000. The schematic diagram is shown in FIG. 3. As can be seen, with a proper curvature and in the watching distances D1, D2, and D3, various viewing angles of the display 310 are the same as a central right viewing angle. Therefore, image quality degradation of the screen caused by viewing at different viewing angles is improved.

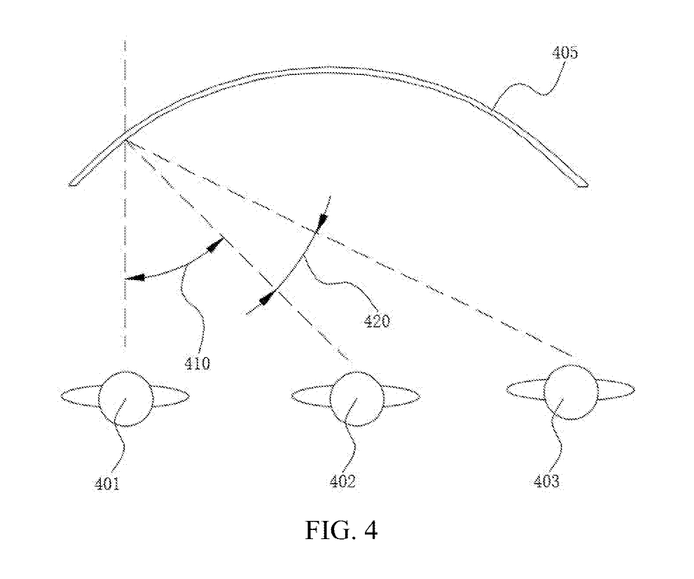

FIG. 4 is another exemplary schematic diagram of a relationship between different viewing angles at which observers 401, 402, and 403 watch a display 405 and different distances between the observers 401, 402, and 403 and the display 405. Referring to FIG. 4, a conventional curved display 405 is designed for one observer 402 in a coordinate location of a central axis (that is, the central location). However, when the display 405 is watched, there is not necessarily only one observer, and the observer does not necessarily watch television at the central location, as shown in FIG. 4. Therefore, conditions of optimal viewing angles 410 and 420 of the curved television 405 may be different with changes of locations of the observers 401, 402, and 403. Consequently, optimal image quality cannot be obtained.

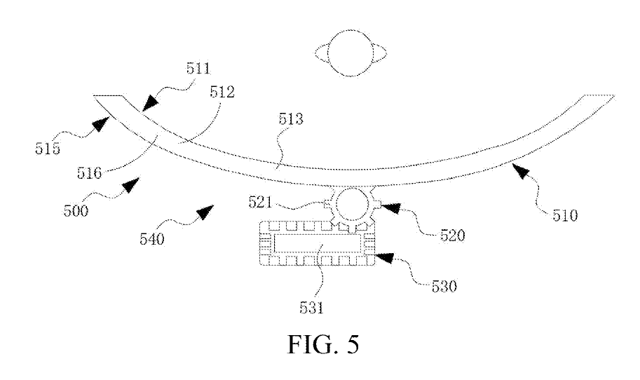

FIG. 5 is a schematic diagram of a curved display apparatus 500 according to an embodiment of this application. Referring to FIG. 5, in an embodiment of this application, a curved display apparatus 500 includes a flexible display module 510 and an angle adjustment module 540. The flexible display module 510 includes: a cover 511, having a first curved surface 512; a backplane 515, disposed opposite to the cover 511 and having a second curved surface 516; and a liquid crystal display panel 513, disposed between the backplane 515 and the cover 511. The angle adjustment module 540 is coupled to the flexible display module 510, is configured to adjust a rotation angle of the flexible display module 510, and includes: a rotation control mechanism unit 520, having a gear 521; and a motor control unit 530, having a motor 531, where the motor 531 is connected to the gear 521.

In an embodiment of this application, the motor 531 in this application is a step motor.

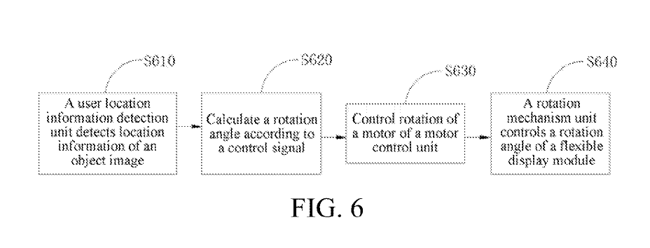

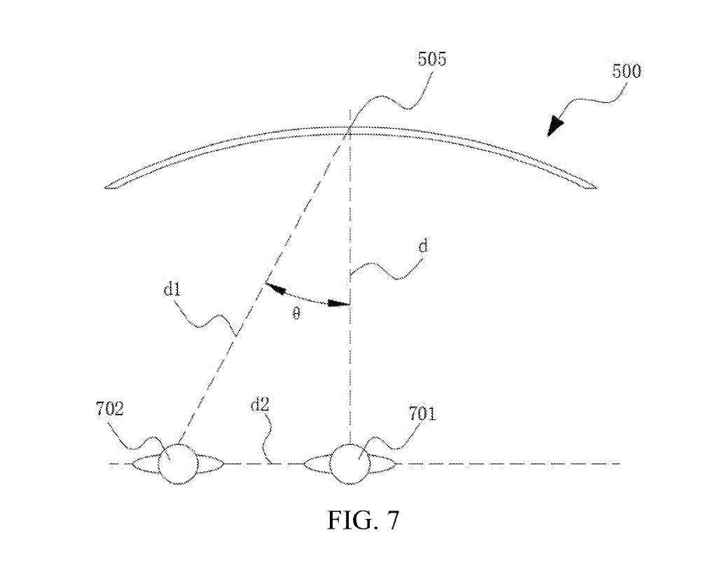

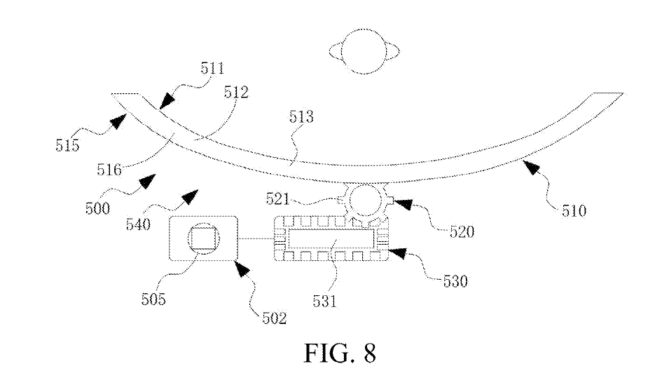

FIG. 6 is a flowchart of a method for controlling a rotation angle of a curved display apparatus 500 according to an embodiment of this application. FIG. 7 is a schematic diagram of a observer location information detection unit 502 configured to detect locations of observers 701 and 702 according to an embodiment of this application. FIG. 8 is a schematic diagram of a curved display apparatus 500 according to another embodiment of this application. Referring to FIG. 6, FIG. 7, and FIG. 8, in an embodiment of this application, a curved display apparatus 500 includes a flexible display module 510 and an angle adjustment module 540. The flexible display module 510 includes: a cover 511, having a first curved surface 512; a backplane 515, disposed opposite to the cover 511 and having a second curved surface 516; and a liquid crystal display panel 513, disposed between the backplane 515 and the cover 511. The angle adjustment module 540 is coupled to the flexible display module 510, is configured to adjust a rotation angle of the flexible display module 510, and includes: a rotation control mechanism unit 520, having a gear 521; a motor control unit 530, having a motor 531, where the motor 531 is connected to the gear 521; and a observer location information detection unit 502, having a charge-coupled assembly 505, electrically coupled to the motor control unit 530, and configured to sense an object image.

In an embodiment, the observer location information detection unit 502 in this application includes a rotation angle calculation assembly, configured to automatically analyze an angle θ by which observers 701 and 702 deviate from a central plane of a display, where tan (θ)=d2/d.

In an embodiment, the observer location information detection unit 502 in this application further includes a signal processor, configured to analyze a distance d2 by which observers 701 and 702 deviate from a center of a display.

In an embodiment, the observer location information detection unit 502 in this application may be preconfigured with a distance d between a display panel and the observer 701, and a distance d1 between the display panel and the observer 702.

In an embodiment, the motor 531 in this application is a step motor.

In an embodiment, the observer location information detection unit 502 in this application may be a sensor chip or a sensor.

Referring to FIG. 6 and FIG. 8, in an embodiment of this application, an intelligent method for controlling a rotation angle of a curved display apparatus 500 includes: providing the curved display apparatus 500. S610: Generate a control signal according to location information of an object image detected by the observer location information detection unit 502. S620: Calculate a rotation angle according to the control signal. S630: Control rotation of the motor 531 of the motor control unit 530. S640: Control a rotation angle of the flexible display module 510 by means of a rotation degree of the rotation control mechanism unit.

In an embodiment, in the method in this application, the step of controlling a rotation angle of the flexible display module 510 by means of a rotation degree of the rotation control mechanism unit 520 includes: connecting to the backplane 515 of the flexible display module 510 by using the rotation control mechanism unit 520; adjusting the second curved surface 516 of the backplane 515 by means of rotation of the gear 521; and adjusting a rotation angle of the first curved surface 512 of the cover 511 by adjusting a rotation angle of the second curved surface 516.

In an embodiment, in the method in this application, the motor 531 is a step motor.

In an embodiment, in the method in this application, the user location information detection unit may be a sensor chip or a sensor.

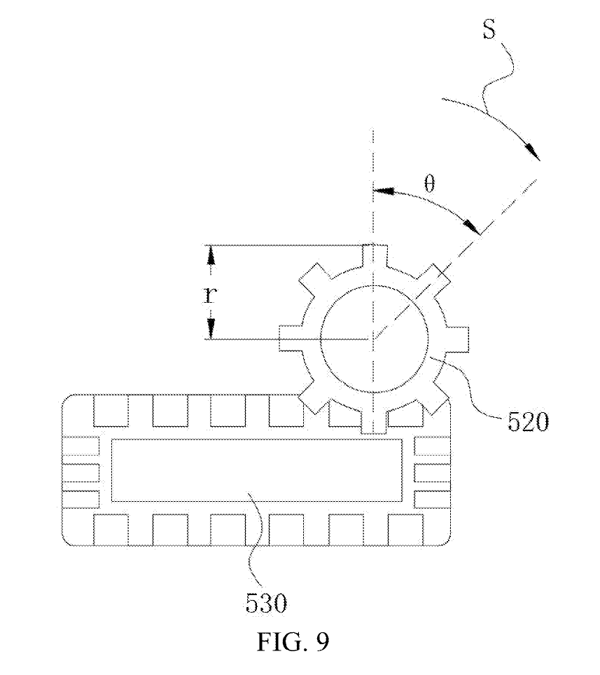

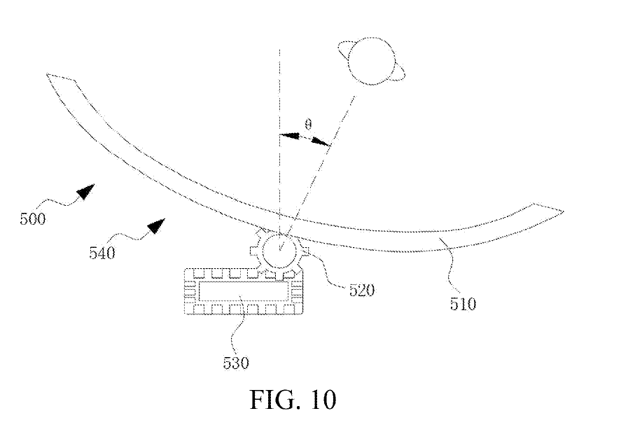

FIG. 9 is a schematic operational diagram of a rotation control mechanism unit 520 according to an embodiment of this application. FIG. 10 is a schematic operational diagram of a curved display apparatus 500 according to an embodiment of this application. Referring to FIG. 7, FIG. 8, FIG. 9, and FIG. 10, in an embodiment of this application, a curved display apparatus 500 includes a flexible display module 510 and an angle adjustment module 540. The flexible display module 510 includes: a cover 511, having a first curved surface 512; a backplane 515, disposed opposite to the cover 511 and having a second curved surface 516; and a liquid crystal display panel 513, disposed between the backplane 515 and the cover 511. The angle adjustment module 540 is coupled to the flexible display module 510, is configured to adjust a rotation angle of the flexible display module 510, and includes: a rotation control mechanism unit 520, having a gear 521; a motor control unit 530, having a motor 531, where the motor 531 is connected to the gear 521; and a observer location information detection unit 502, having a charge-coupled assembly 505, electrically coupled to the motor control unit 530, and configured to sense an object image.

In an embodiment, the observer location information detection unit 502 in this application includes a rotation angle calculation assembly, electrically connected to the motor control unit 530 by using a transmission interface, and controlling a rotation angle θ required by the motor 531.

In an embodiment, the motor control unit 530 in this application receives angle information provided by the rotation angle calculation assembly, and converts the angle information into a relative rotation physical quantity S (r×θ) (the rotation physical quantity=a gear radius×an angle at which a observer deviates from a central plane of the display).

By means of this application, a rotation angle of a display is automatically adjusted according to a location change of a observer, to adjust a rotation angle of a curved display apparatus, thereby greatly improving image quality in a large viewing angle of an observer.

“In some embodiments”, “in various embodiments”, and the like are repeatedly used. They usually do not refer to a same embodiment; but they may refer to a same embodiment. Terms such as “contain”, “have”, and “include” are synonyms, unless the context requires otherwise.

Descriptions above are merely preferred embodiments of this application, and are not intended to limit this application. Although this application has been disclosed above in forms of preferred embodiments, the embodiments are not intended to limit this application. A person skilled in the art can make some equivalent variations, alterations or modifications to the above disclosed technical content without departing from the scope of the technical solutions of the above disclosed technical content to obtain equivalent embodiments. Any simple alteration, equivalent change or modification made to the foregoing embodiments according to the technical essence of this application without departing from the content of the technical solutions of this application shall fall within the scope of the technical solutions of this application.

What is claimed is:

1. A curved display apparatus, comprising:
a flexible display module; and
an angle adjustment module, coupled to the flexible display module, and configured to adjust a rotation angle of the flexible display module.

2. The curved display apparatus according to 1, wherein the flexible display module comprises: a cover, having a first curved surface; and a backplane, disposed opposite to the cover and having a second curved surface.

3. The curved display apparatus according to 2, wherein the flexible display module further comprises: a liquid crystal display panel, disposed between the backplane and the cover.

4. The curved display apparatus according to claim 1, wherein the angle adjustment module comprises:
a rotation control mechanism unit, having a gear;
a motor control unit, having a motor, wherein the motor is connected to the gear; and
a observer location information detection unit, electrically coupled to the motor control unit, and configured to sense a object image.

5. The curved display apparatus according to claim 4, wherein the motor is a step motor.

6. The curved display apparatus according to claim 4, wherein the observer location information detection unit comprises a rotation angle calculation assembly, configured to automatically analyze an angle by which a observer deviates from a central plane of the flexible display module.

7. The curved display apparatus according to claim 4, wherein the observer location information detection unit further comprises a signal processor, configured to analyze a distance by which an observer deviates from a center of the flexible display module.

8. The curved display apparatus according to claim 4, wherein the observer location information detection unit is a charge-coupled assembly.

9. A method for controlling a rotation angle of a curved display apparatus, comprising:
providing the curved display apparatus according to claim 1;
generating a control signal according to location information of a object image detected by the observer location information detection unit;
controlling rotation of the motor of the motor control unit according to the control signal; and
controlling a rotation angle of the flexible display module by means of a rotation degree of the rotation control mechanism unit.

10. The method for controlling a rotation angle of a curved display apparatus according to claim 9, wherein the step of controlling a rotation angle of the flexible display module by means of a rotation degree of the rotation control mechanism unit comprises:
coupling to the backplane of the flexible display module by using the rotation control mechanism unit;
adjusting a rotation angle of the second curved surface of the backplane by means of rotation of the gear; and
adjusting a rotation angle of the first curved surface of the cover by adjusting the rotation angle of the second curved surface.

11. The method for controlling a rotation angle of a curved display apparatus according to claim 9, wherein the flexible display module comprises: a cover, having first curved surface; and a backplane, disposed opposite to the cover and having a second curved surface.

12. The method for controlling a rotation angle of a curved display apparatus according to 11, wherein the flexible display module further comprises: a liquid crystal display panel, disposed between the backplane and the cover.

13. The method for controlling a rotation angle of a curved display apparatus according to claim 9, wherein the angle adjustment module comprises:
a rotation control mechanism unit, having a gear;
a motor control unit, having a motor, wherein the motor is connected to the gear; and
a observer location information detection unit, electrically coupled to the motor control unit, and configured to sense a object image.

14. The method for controlling a rotation angle of a curved display apparatus according to claim 13, wherein the motor is a step motor.

15. The method for controlling a rotation angle of a curved display apparatus according to claim 13, wherein the observer location information detection unit comprises a rotation angle calculation assembly, configured to automatically analyze an angle by which a observer deviates from a central plane of the flexible display module.

16. The method for controlling a rotation angle of a curved display apparatus according to claim 13, wherein the observer location information detection unit further comprises a signal processor, configured to analyze a distance by which a observer deviates from a center of the flexible display module.

17. The method for controlling a rotation angle of a curved display apparatus according to claim 13, wherein the observer location information detection unit is a charge-coupled assembly.

18. A curved display apparatus, comprising:
a flexible display module; and
an angle adjustment module, coupled to the flexible display module, and configured to adjust a rotation angle of the flexible display module, wherein
wherein the flexible display module comprises: a cover, having a first curved surface; a backplane, disposed opposite to the cover and having a second curved surface; and a liquid crystal display panel, disposed between the backplane and the cover;
wherein the angle adjustment module comprises: a rotation control mechanism unit, having a gear; a motor control unit, having a motor, wherein the motor is connected to the gear; and a observer location information detection unit, electrically coupled to the motor control unit, and configured to sense a object image;
wherein the observer location information detection unit comprises a rotation angle calculation assembly, configured to automatically analyze an angle by which a observer deviates from a central plane of the flexible display module; and a signal processor, configured to analyze a distance by which the observer deviates from a center of the flexible display module; and
wherein the observer location information detection unit is a charge-coupled assembly, and the observer location information detection unit may be a sensor chip or a sensor.
